(19) United States
(12) Patent Application Publication
(10) Pub. No.: US 2008/0125979 A1
(43) Pub. Date: May 29, 2008

(54) Method and system for determining ranges for the boundaries of chromosomal aberrations

(76) Inventors: Zohar Yakhini, Ramat HaSharon (IL); John F. Corson, Mountain View, CA (US); Amir Ben-Dor, Bellevue, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/580,973

(22) Filed: Oct. 13, 2006

(51) Int. Cl. G06F 19/00

(52) U.S. Cl. 702/20

(57) ABSTRACT

Embodiments of the present invention include methods and systems for analysis of comparative genomic hybridization (“CGH”) data, including CGH data obtained from microarray experiments.

### BACKGROUND

The present invention is related to analysis of experimental data and, in particular, to a method and system for identifying biopolymer-sequence abnormalities, including amplifications and deletions of subsequences of the DNA sequence of a chromosomal DNA, in samples of interest compared to control samples by array-based comparative hybridization.

### SUMMARY OF THE INVENTION

Embodiments of the present invention include methods and systems for analysis of comparative hybridization data, including comparative genomic hybridization (“CGH”) data, such as CGH data obtained from microarray experiments. Various embodiments of the present invention include determining confidence ranges for the boundaries of a chromosomal copy number variation region as well as confidence ranges for the height (or copy number variation value) of the chromosomal copy number variation region. When combined with microarray-based experimental systems, the present invention provides a more informative and precise reporting mechanism for chromosomal abnormalities, including amplified and deleted DNA subsequences based on CGH data.

### BRIEF DESCRIPTION OF THE DRAWINGS

The patent or application file contains at least one drawing executed in color. Copies of this patent application publication with color drawing(s) will be provided by the U.S. Patent and Trademark Office upon request and payment of the necessary fee.

FIG. 1 shows the chemical structure of a small, four-subunit, single-chain oligonucleotide.

FIG. 2 shows a symbolic representation of a short stretch of double-stranded DNA.

FIG. 3 illustrates construction of a protein based on the information encoded in a gene.

FIG. 4 shows a hypothetical set of chromosomes for a very simple, hypothetical organism.

FIG. 5 shows examples of gene deletion and gene amplification in the context of the hypothetical genome shown in FIG. 4.

FIGS. 6-7 illustrate detection of gene amplification by CGH.

FIGS. 8-9 illustrate detection of gene deletion by CGH.

FIGS. 10-12 illustrate microarray-based CGH.

FIG. 13 illustrates one method for identifying and ranking intervals and removing redundancies from lists of intervals identified as probable deletions or amplifications.

FIG. 14 shows a screen capture of an exemplary range boundary visualization scheme in accordance with the present invention.

### DETAILED DESCRIPTION OF THE INVENTION

Embodiments of the present invention provide methods and systems for analysis of comparative genomic hybridization (“CGH”) data. The methods and systems are general, and applicable to biomolecular copy number variation data obtained from a variety of different experimental approaches and protocols. Described embodiments, below, are particularly applicable to microarray-based CGH data, obtained from high-resolution microarrays containing oligonucleotide probes that provide relatively uniform and closely-spaced coverage of the DNA sequence or sequences representing some or all of one or more chromosomes from an organism. Aspects of the present invention find use in determining a range for a boundary of a copy number variation region identified in a biopolymer sequence, sometimes referred to as a confidence interval. In certain embodiments, a range for the height of the copy number variation region is determined. Aspects of the systems and methods of the subject invention further include visualizing the ranges for the boundaries and height of the copy number variation interval determined on a graphical display.

### Identification of Copy Number Variation Interval Using Comparative Genome Hybridization

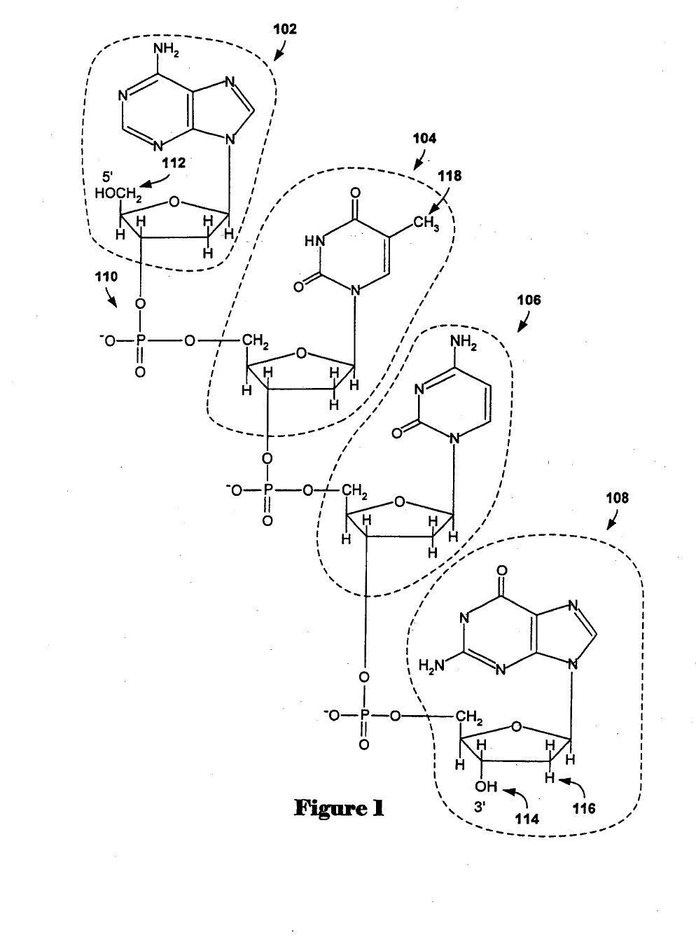

Prominent information-containing biopolymers include deoxyribonucleic acid (“DNA”), ribonucleic acid (“RNA”), including messenger RNA (“mRNA”), and proteins. FIG. 1 shows the chemical structure of a small, four-subunit, single-chain oligonucleotide, or short DNA polymer. The oligonucleotide shown in FIG. 1 includes four subunits: (1) deoxyadenosine 102, abbreviated “A”; (2) deoxythymidine 104, abbreviated “T”; (3) deoxycytodine 106, abbreviated “C”; and (4) deoxyguanosine 108, abbreviated “G.” Each subunit 102, 104, 106, and 108 is generically referred to as a “deoxyribonucleotide,” and consists of a purine, in the case of A and G, or pyrimidine, in the case of C and T, covalently linked to a deoxyribose. The deoxyribonucleotide subunits are linked together by phosphate bridges, such as phosphate 110. The oligonucleotide shown in FIG. 1, and all DNA polymers, is asymmetric, having a 5′ end 112 and a 3′ end 114, each end comprising a chemically active hydroxyl group. RNA is similar, in structure, to DNA, with the exception that the ribose components of the ribonucleotides in RNA have a 2′ hydroxyl instead of a 2′ hydrogen atom, such as 2′ hydrogen atom 116 in FIG. 1, and include the ribonucleotide uridine, similar to thymidine but lacking the methyl group 118, instead of a ribonucleotide analog to deoxythymidine. The RNA subunits are abbreviated A, U, C, and G.

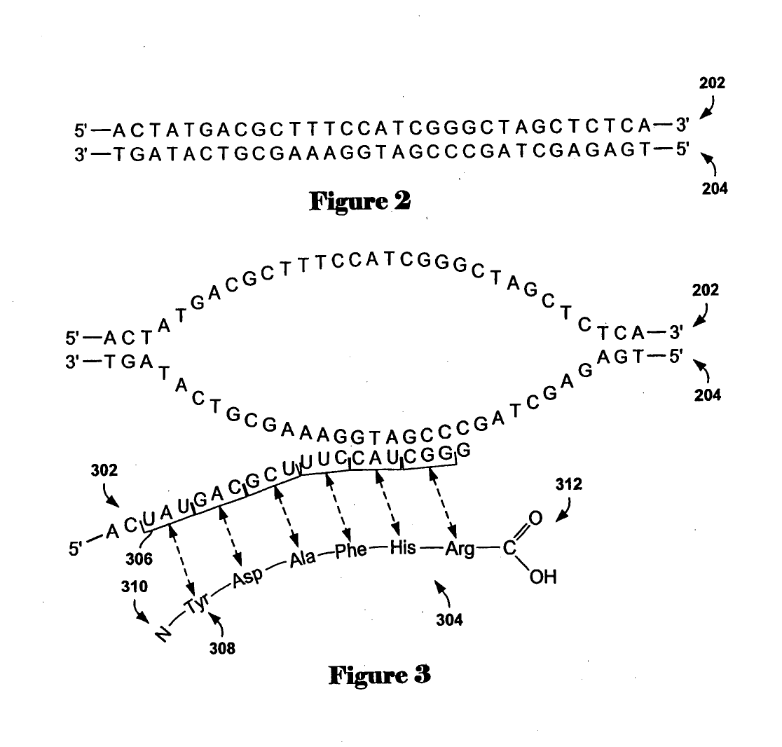

In cells, DNA is generally present in double-stranded form, in the familiar DNA-double-helix form. FIG. 2 shows a symbolic representation of a short stretch of double-stranded DNA. The first strand 202 is written as a sequence of deoxyribonucleotide abbreviations in the 5′ to 3′ direction and the complementary strand 204 is symbolically written in 3′ to 5′ direction. Each deoxyribonucleotide subunit in the first strand 202 is paired with a complementary deoxyribonucleotide subunit in the second strand 204. In general, a G in one strand is paired with a C in a complementary strand, and an A in one strand is paired with a T in a complementary strand. One strand can be thought of as a positive image, and the opposite, complementary strand can be thought of as a negative image, of the same information encoded in the sequence of deoxyribonucleotide subunits.

A gene is a subsequence of deoxyribonucleotide subunits within one strand of a double-stranded DNA polymer. A gene can be thought of as an encoding that specifies, or a template for, construction of a particular protein. FIG. 3 illustrates construction of a protein based on the information encoded in a gene. In a cell, a gene is first transcribed into single-stranded mRNA. In FIG. 3, the double-stranded DNA polymer composed of strands 202 and 204 has been locally unwound to provide access to strand 204 for transcription machinery that synthesizes a single-stranded mRNA 302 complementary to the gene-containing DNA strand. The single-stranded mRNA is subsequently translated by the cell into a protein polymer 304, with each three-ribonucleotide codon, such as codon 306, of the mRNA specifying a particular amino acid subunit of the protein polymer 304. For example, in FIG. 3, the codon “UAU” 306 specifies a tyrosine amino-acid subunit 308. Like DNA and RNA, a protein is also asymmetrical, having an N-terminal end 310 and a carboxylic acid end 312.

In eukaryotic organisms, including humans, each cell contains a number of extremely long, DNA-double-strand polymers called chromosomes. Each chromosome can be thought of, abstractly, as a very long deoxyribonucleotide sequence. Each chromosome contains hundreds to thousands of subsequences corresponding to genes. The exact correspondence between a particular subsequence identified as a gene and the protein encoded by the gene can be somewhat complicated, for reasons outside the scope of the present invention. However, for the purposes of describing embodiments of the present invention, a chromosome may be thought of as a linear DNA sequence of contiguous deoxyribonucleotide subunits that can be viewed as a linear sequence of DNA subsequences. In certain cases, the subsequences are genes, each gene specifying a particulars protein. But these embodiments are far more general. Amplification and deletion of any DNA subsequence or group of DNA subsequences can be detected by the described methods, regardless of whether or not the DNA subsequences correspond to protein-sequence-specifying, biological genes, to DNA subsequences specifying various types of non-protein-encoding RNAs, or to other regions with defined biological roles. Moreover, these methods may be applied to other types of biopolymers to detect changes in biopolymer-subsequence occurrence. The term “gene” is used in the following as a notational convenience, and should be understood as simply an example of a “biopolymer subsequence.” Similarly, although the described embodiments are directed to analyzing DNA chromosomal sequences, the sequences of any information-containing biopolymer are analyzable by methods of the present invention. Therefore, the term “chromosome,” and related terms, are used in the following as a notational convenience, and should be understood as an example of a biopolymer or biopolymer sequence.

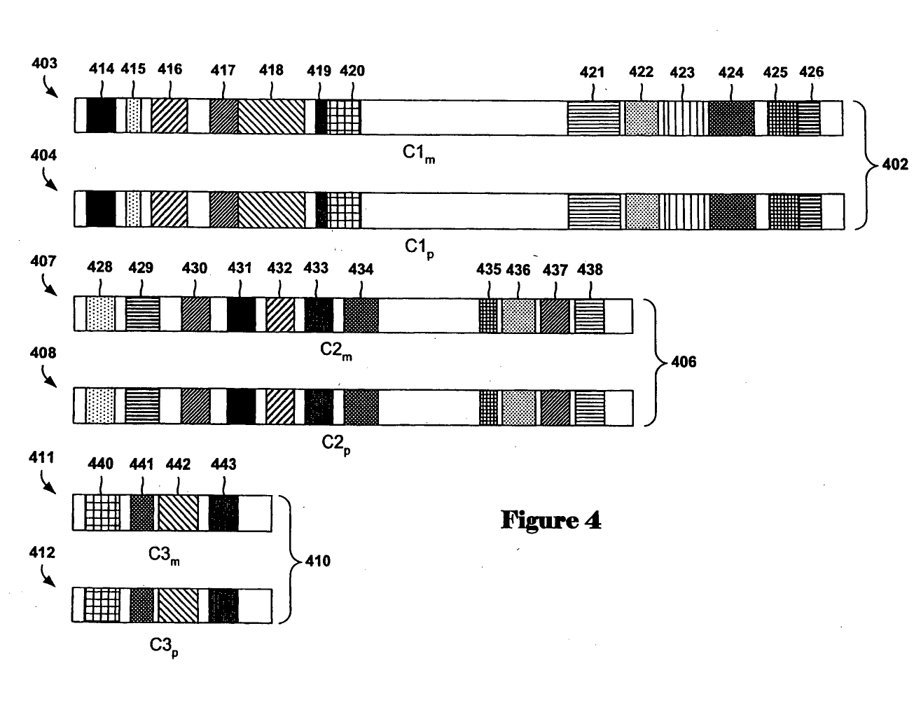

FIG. 4 shows a hypothetical set of chromosomes for a very simple, hypothetical organism. The hypothetical organism includes three pairs of chromosomes 402, 406, and 410. Each chromosome in a pair of chromosomes is quite similar, generally having identical genes at identical positions along the lines of the chromosome. In FIG. 4, each gene is represented as a subsection of the chromosome. For example, in the first chromosome 403 of the first chromosome pair 402, 13 genes are shown, 414-426.

As shown in FIG. 4, the second chromosome 404 of the first pair of chromosomes 402 includes the same genes at the same positions. Each chromosome of the second pair of chromosomes 406 includes eleven genes 428-438, and each chromosome of the third pair of chromosomes 410 includes four genes 440-443. Of course, in a real organism, there are generally many more chromosome pairs, and each chromosome includes many more genes. However, the simplified, hypothetical genome shown in FIG. 4 is more suitable for simply describing embodiments of the present invention. Note that, in each chromosome pair, one chromosome is originally obtained from the mother of the organism, and the other chromosome is originally obtained from the father of the organism. Thus, the chromosomes of the first chromosome pair 402 are referred to as chromosome “C1ₘ” and “C1ₚ.” While, in general, each chromosome of a chromosome pair has the same genes positioned at the same location along the length of the chromosome, the genes inherited from one parent may differ slightly from the genes inherited from the other parent. Different versions of a gene are referred to as alleles. Common differences include single-deoxyribonucleotide-subunit substitutions at various positions within the DNA subsequence corresponding to a gene.

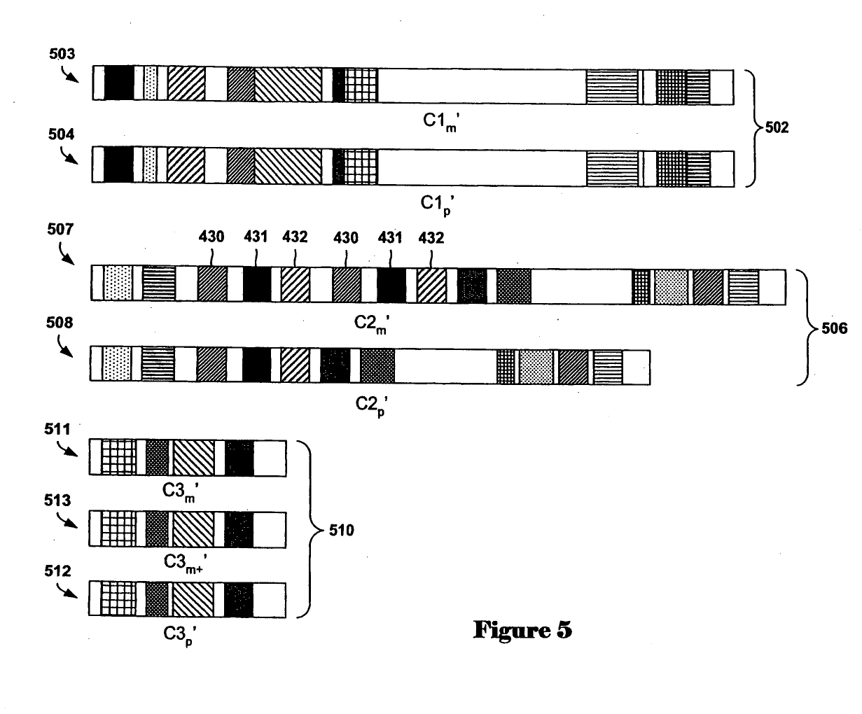

Although differences between genes and mutations of genes may be important in the predisposition of cells to various types of cancer, and related to cellular mechanisms responsible for cell transformation, cause-and-effect relationships between different forms of genes and pathological conditions are often difficult to elucidate and prove, and very often indirect. However, other genomic abnormalities are more easily associated with pre-cancerous and cancerous tissues. Two prominent types of genomic aberrations include gene amplification and gene deletion. FIG. 5 shows examples of gene deletion and gene amplification in the context of the hypothetical genome shown in FIG. 4. First, both chromosomes C1ₘ′ 503 and chromosome C1ₚ′ 504 of the variant, or mutant, first chromosome pair 502 are shorter than the corresponding wild-type chromosomes C1ₘ and C1ₚ in the first pair of chromosomes 402 shown in FIG. 4. This shortening is due to deletion of genes 422, 423, and 424, present in the wild-type chromosomes 403 and 404, but absent in the variant chromosomes 503 and 504. This is an example of a double, or homozygous-gene-deletion. Small scale variations of DNA copy numbers can also exist in normal cells. These can have phenotypic implications, and can also be measured by CGH methods and analyzed by the methods of the present invention.

Generally, deletion of single or multiple, contiguous genes is observed, corresponding to the deletion of a substantial subsequence from the DNA sequence of a chromosome. Much smaller subsequence deletions may also be observed, leading to mutant and often nonfunctional genes. A gene deletion may be observed in only one of the two chromosomes of a chromosome pair, in which case a gene deletion is referred to as being heterozygous. A second chromosomal abnormality in the altered genome shown in FIG. 5 is duplication of genes 430, 431, and 432 in the maternal chromosome C2ₘ′ 507 of the second chromosome pair 506. Duplication of one or more contiguous genes within a chromosome is referred to as gene amplification. In the example altered genome shown in FIG. 5, the gene amplification in chromosome C2ₘ′ is heterozygous, since gene amplification does not occur in the other chromosome of the pair C2ₚ′ 508. The gene amplification illustrated in FIG. 5 is a two-fold amplification, but three-fold and higher-fold amplifications are also observed. An extreme chromosomal abnormality is illustrated with respect to the third chromosome pair (410 in FIG. 4). In the altered genome illustrated in FIG. 5, the entire maternal chromosome 511 has been duplicated from a third chromosome 513, creating a chromosome triplet 510 rather than a chromosome pair. This three-chromosome phenomenon is referred to as a trisomy in the third chromosome-pair. The trisomy shown in FIG. 5 is an example of heterozygous gene amplification, but it is also observed that both chromosomes of a chromosome pair may be duplicated, higher-order amplification of chromosomes may be observed, and heterozygous and homozygous deletions of entire chromosomes may also occur. While whole organisms having certain of these chromosomal alterations are non-viable, they can be observed in cancer cell genomes and tumor cells derived from an organism and in many instances can proliferate very effectively.

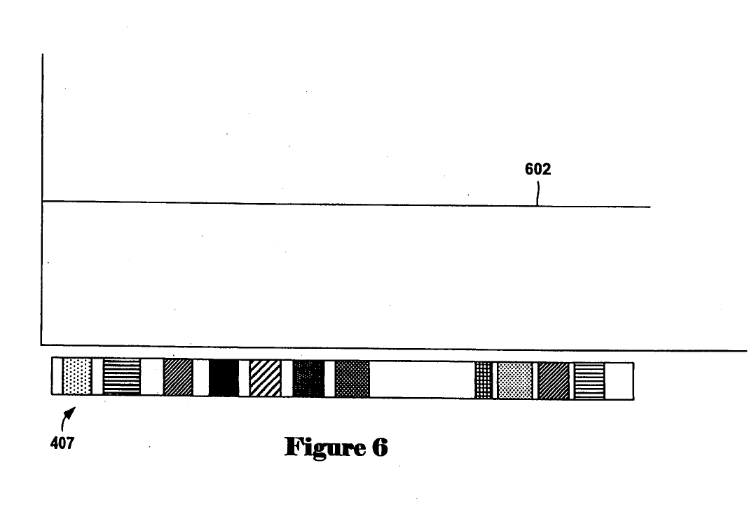

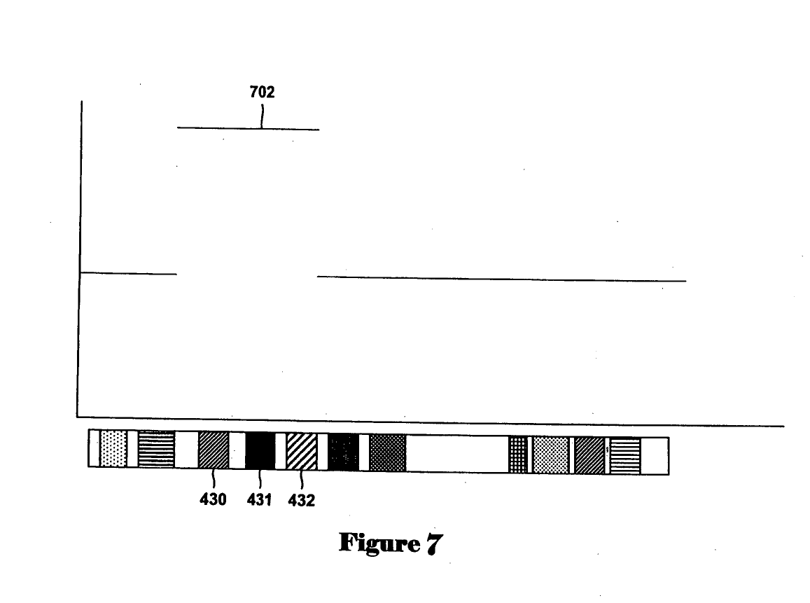

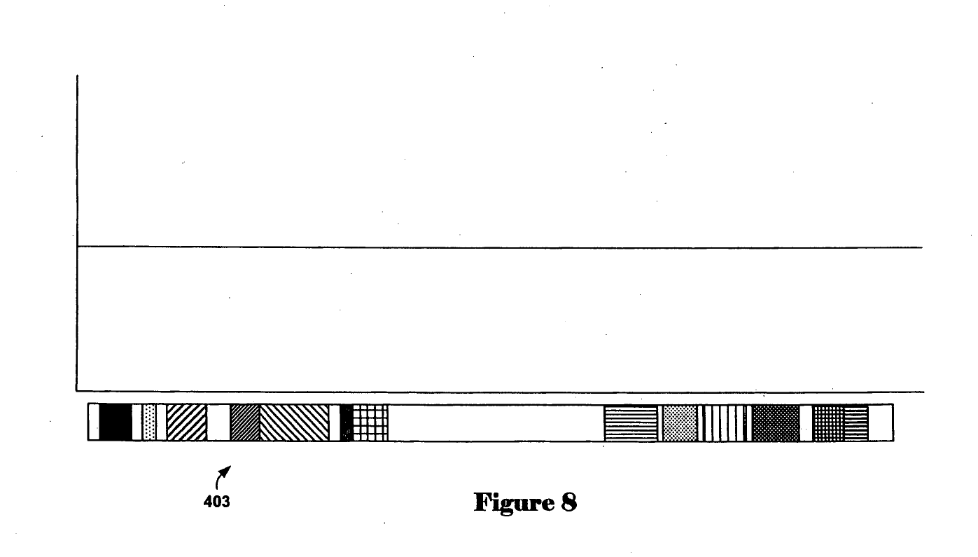

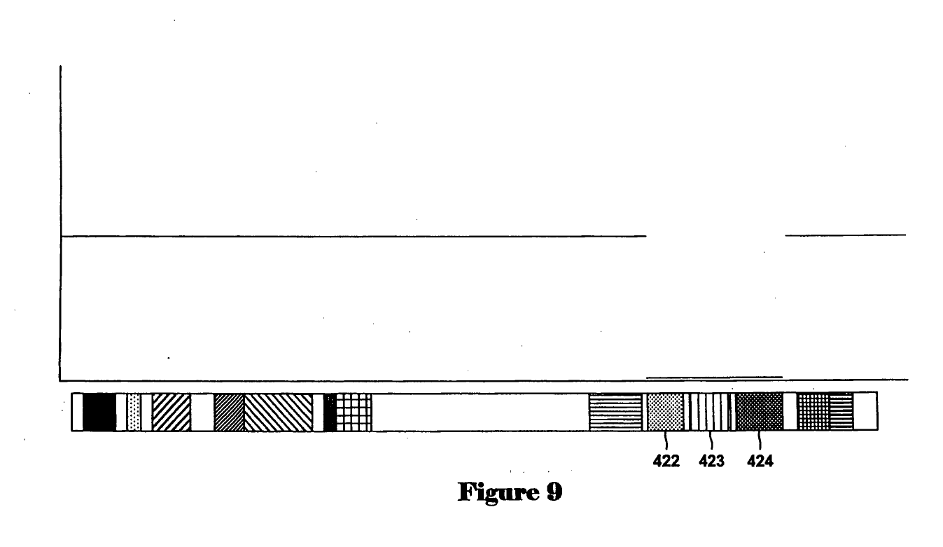

Changes in the DNA copy number, either by amplification or deletion, can be detected by comparative genomic hybridization (“CGH”) techniques. FIGS. 6-7 illustrate one example for the detection of gene amplification by CGH, and FIGS. 8-9 illustrate one example for the detection of gene deletion by CGH. CGH assays shown in these figures involves analysis of the relative level of binding of chromosome fragments from sample tissues to single-stranded, normal chromosomal DNA. The tissues-sample fragments hybridize to complementary regions of the normal, single-stranded DNA by complementary binding to produce short regions of double-stranded DNA. Hybridization occurs when a DNA fragment is exactly complementary, or nearly complementary, to a subsequence within the single-stranded chromosomal DNA. In FIG. 6, and in subsequent figures, one of the hypothetical chromosomes of the hypothetical wild-type genome shown in FIG. 4 is shown below the x axis of a graph, and the level of sample fragment binding to each portion of the chromosome is shown along with the y axis. In FIG. 6, the graph of fragment binding is a horizontal line 602 indicative of generally uniform fragment binding along the length of the chromosome 407. Of course, in an actual experiment, uniform and complete overlap of DNA fragments prepared from tissue samples may not be possible, leading to discontinuities and non-uniformities in detected levels of fragment binding along the length of a chromosome. However, in general, fragments of a normal chromosome isolated from normal tissue samples should, at least, provide a binding-level trend approaching a horizontal line, such as line 602 in FIG. 6. By contrast, CGH data for fragments prepared from the mutant genotype illustrated in FIG. 5 should generally show an increased binding level for those genes amplified in the mutant genotype.

FIG. 7 shows hypothetical CGH data for fragments prepared from tissues with the mutant genotype illustrated in FIG. 5. As shown in FIG. 7, an increased binding level 702 is observed for the three genes 430-432 that are amplified in the altered genome. In other words, the fragments prepared from the altered genome should be enriched in those gene fragments from genes which are amplified. Moreover, in quantitative CGH, the relative increase in binding should be reflective of the increase in a number of copies of particular genes.

FIG. 8 shows hypothetical CGH data for fragments prepared from normal tissue with respect to the first hypothetical chromosome 403. Again, the CGH-data trend expected for fragments prepared from normal tissue is a horizontal line indicating uniform fragment binding along the length of the chromosome. By contrast, the homozygous gene deletion in chromosomes 503 and 504 in the altered genome illustrated in FIG. 5 should be reflected in a relative decrease in binding with respect to the deleted genes. FIG. 9 illustrates hypothetical CGH data for DNA fragments prepared from the hypothetical altered genome illustrated in FIG. 5 with respect to a normal chromosome from the first pair of chromosomes (402 in FIG. 4). As seen in FIG. 9, no fragment binding is observed for the three deleted genes 422, 423, and 424.

CGH data may be obtained by a variety of different experimental techniques. In one technique, DNA fragments are prepared from tissue samples and labeled with a particular chromophore. The labeled DNA fragments are then hybridized with single-stranded chromosomal DNA from a normal cell, and the single-stranded chromosomal DNA then visually inspected via microscopy to determine the intensity of light emitted from labels associated with hybridized fragments along the length of the chromosome. Areas with relatively increased intensity reflect regions of the chromophore amplified in the corresponding tissue chromosome, and regions of decreased emitted signal indicate deleted regions in the corresponding tissue chromosome. In other techniques, normal DNA fragments labeled with a first chromophore are competitively hybridized to a normal single-stranded chromosome with fragments isolated from abnormal tissue, labeled with a second chromophore. Relative binding of normal and abnormal fragments can be detected by ratios of emitted light at the two different intensities corresponding to the two different chromophore labels.

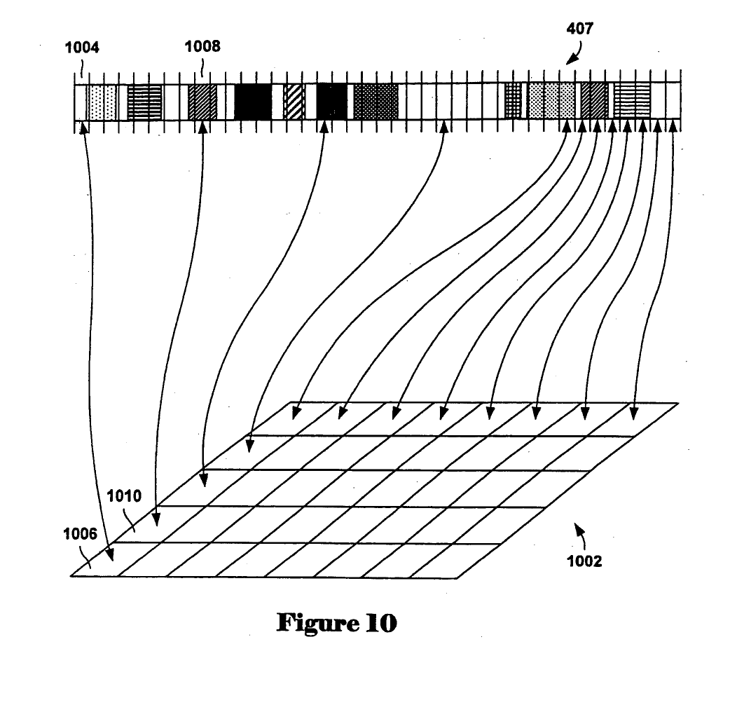

A third type of CGH is referred to as microarray-based CGH (“aCGH”). FIGS. 10-12 illustrate microarray-based CGH. In FIG. 10, synthetic probe oligonucleotides having sequences equal to contiguous subsequences of hypothetical chromosome 407 and/or 408 in the hypothetical, normal genome illustrated in FIG. 4, are prepared as features on the surface of the microarray 1002. For example, a synthetic probe oligonucleotide having the sequence of one strand of the region 1004 of chromosome 407 and/or 408 is synthesized in feature 1006 of the hypothetical microarray 1002. Similarly, an oligonucleotide probe corresponding to subsequence 1008 of chromosome 407 and/408 is synthesized to produce the oligonucleotide probe molecules of feature 1010 of microarray 1002. In actual cases, probe molecules may be much shorter relative to the length of the chromosome, and multiple, different, overlapping and non-overlapping probes/features may target a particular gene. Nonetheless, there is a definite, well-known correspondence between microarray features and genes.

The microarray may be exposed to sample solutions containing fragments of DNA. In one version of aCGH, an array may be exposed to fragments, labeled with a first chromophore, prepared from abnormal tissue and to fragments, labeled with a second chromophore, prepared from normal tissue. The normalized ratio of signal emitted from the first chromophore versus signal emitted from the second chromophore for each feature provides a measure of the relative abundance of the portion of the normal chromosome corresponding to the feature in the abnormal tissue versus the normal tissue. In the hypothetical microarray 1002 of FIG. 10, each feature corresponds to a different interval along the length of chromosome 407 and/408 in the hypothetical wild-type genome illustrated in FIG. 4. When fragments prepared from a normal tissue sample, labeled with a first chromophore, and DNA fragments prepared from normal tissue labeled with the second chromophore, are both hybridized to the hypothetical microarray shown in FIG. 10, and normalized intensity ratios for light emitted by the first and second chromophores are determined, the normalized ratios for all features should be relatively uniformly equal to one.

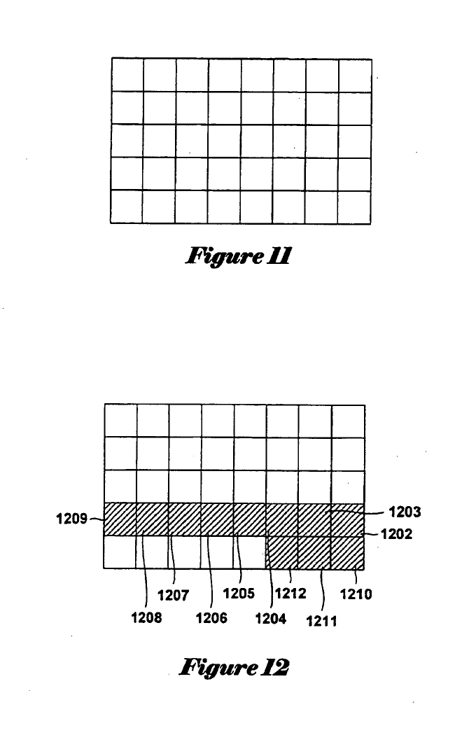

FIG. 11 represents an aCGH data set for two normal, differentially labeled samples hybridized to the hypothetical microarray shown in FIG. 10. The normalized ratios of signal intensities from the first and second chromophores are all approximately unity, shown in FIG. 11, by log ratios for all features of the hypothetical microarray 1002 displayed in the same color. By contrast, when DNA fragments isolated from tissues having the mutant genotype, illustrated in FIG. 5, labeled with a first chromophore are hybridized to the microarray, and DNA fragments prepared from normal tissue, labeled with a second chromophore, are hybridized to the microarray, then the ratios of signal intensities of the first chromophore versus the second chromophore vary significantly from unity in those features containing probe molecules equal to, or complementary to, subsequences of the amplified genes 430, 431, and 432. As shown in FIG. 12, increase in the ratio of signal intensities from the first and second chromophores, indicated by darkened features, are observed in those features 1202-1212 with probe molecules equal to, or complementary to, subsequences spanning the amplified genes 430, 431, and 432. Similarly, a decrease in signal intensity ratios indicates gene deletion in the abnormal tissues.

Further computational and experimental refinements of CGH assays have been described which aid in the identification of copy number variations in a biopolymeric sequence (see, e.g., U.S. patent application Ser. No. 11/492,472, filed on Jul. 24, 2006 and having attorney docket no. 10060627-1 and U.S. patent application Ser. No. 11/492,377, filed on Jul. 24, 2006 and having attorney docket no. 10060632-1, both of which are incorporated by reference herein in their entirety).

Microarray-based CGH data obtained from microarray experiments provide a relatively precise measure of the relative or absolute number of copies of genes in cells of a sample tissue. Sets of aCGH data obtained from pre-cancerous and cancerous tissues at different points in time can be used to monitor genome instability in particular pre-cancerous and cancerous tissues. Quantified genome instability can then be used to detect and follow the course of particular types of cancers. Moreover, quantified genome instabilities in different types of cancerous tissue can be compared in order to elucidate common chromosomal abnormalities, including gene amplifications and gene deletions, characteristic of different classes of cancers and pre-cancerous conditions.

The methods of the present invention may be applied to analysis of any type of sample, including diseased-tissue samples, samples produced by particular experiments, samples produced at particular times during particular experiments, and other samples of interest. The phrase “diseased tissue sample” is therefore interchangeable, in the following discussions, with the phrase “sample of interest.”

As reviewed above, an aCGH array may contain a number of different features, each feature generally containing a particular type of probe, each probe targeting a particular chromosomal DNA subsequence indexed by index k that represents a genomic location. A subsequence indexed by index k is referred to as “subsequence k.”

One can define the signal generated for subsequence k as the sum of the normalized log-ratio signals from the different probes targeting subsequence k divided by the number of probes targeting subsequence k or, in other words, the average log-ratio signal value generated from the probes targeting subsequence k, as follows:

$$C ( k ) = \frac{{\sum }_{b ∈ \{ features containing probes for k \}} C ( b )}{{num\_features}_{k}}$$

where num_featuresₖ is the number of features that target the subsequence k;

C(b) is the normalized log-ratio signal measured for feature b,

$$C ( b ) = {log ( \frac{{J}_{red}}{{J}_{green}} )}_{b} - \frac{{\sum }_{i ∈ \{ allfeatures \}} {log ( \frac{{J}_{red}}{{J}_{green}} )}_{i}}{num\_features} ;$$

and

$${( \frac{{J}_{red}}{{J}_{green}} )}_{i}$$

is the ratio of measured red signal J_{red} to measured green signal J_{green} for feature i.

### In the case where a single probe targets a particular subsequence, k, no averaging is needed.

C(k) is sometimes denoted below as the height (h) of subsequence k.

As such, each aCGH data point may be viewed as a log ratio of signals read from a particular feature of a microarray that contains probes targeting a particular subsequence, the log-ratio of signals representing the ratio of signals emitted from a first label (e.g., red) used to label fragments of a genome sample and from a second label (e.g., green) used to label fragments of a normal, control genome. Both the sample-genome fragments and the normal, control fragments hybridize to normal-tissue-derived probe molecules on the microarray. A normal tissue or sample may be any tissue or sample selected as a control tissue or sample for a particular experiment. The term “normal” does not necessarily imply that the tissue or sample represents a population average, a non-diseased tissue, or any other subjective or objective classification. The sample genome may be obtained from a diseased or cancerous tissue, in order to compare the genetic state of the diseased or cancerous tissue to a normal tissue, but may also be a normal tissue.

Subsequence deletions and amplifications generally span a number of contiguous subsequences of interest, such as genes, control regions, or other identified subsequences, along a chromosome. It therefore makes sense to analyze aCGH data in a chromosome-by-chromosome fashion, statistically considering groups of consecutive subsequences along the length of the chromosome in order to more reliably detect amplification and deletion. Specifically, it is assumed that the noise of measurement is independent for each subsequence along the chromosome, and independent for distinct probes. Statistical measures are employed to identify sets of consecutive subsequences for which deletion or amplification is relatively strongly indicated. This tends to ameliorate the effects of spurious, single-probe anomalies in the data. This is an example of an aberration-calling technique, in which gene-copy anomalies appearing to be above the data-noise level are identified.

One can consider the measured, normalized, or otherwise processed signals for subsequences along the chromosome of interest to be a vector V as follows:

V={v₁, v₂, . . . vₙ}

where vₖ=C(k)
Note that the vector, or set V, is sequentially ordered by position of subsequences along the chromosome. A statistic S is computed for each interval I of subsequences along the chromosome as follows:

$$S ( I ) = ( {\sum }_{k = i , … , j} {v}_{k} ) \cdot \frac{1}{\sqrt{j - i + 1}}$$

where I=vᵢ, . . . , vⱼ

Under a null model assuming no sequence aberrations, the statistic S has a normal distribution of values with mean=0 and variance=1, independent of the number of probes included in the interval I. The statistical significance of the normalized signals for the subsequences in an interval I can be computed by a standard probability calculation based on the area under the normal distribution curve:

$$Prob ( \vert S ( I ) \vert > z ) \approx ( \frac{1}{\sqrt{2 π}} ) \frac{1}{z} {e}^{- \frac{{z}^{2}}{2}}$$

### Alternatively, the magnitude of S(I) can be used as a basis for determining alteration.

It should be noted that various different interval lengths may be used, iteratively, to compute amplification and deletion probabilities over a particular biopolymer sequence. In other words, a range of interval sizes can be used to refine amplification and deletion indications over the biopolymer.

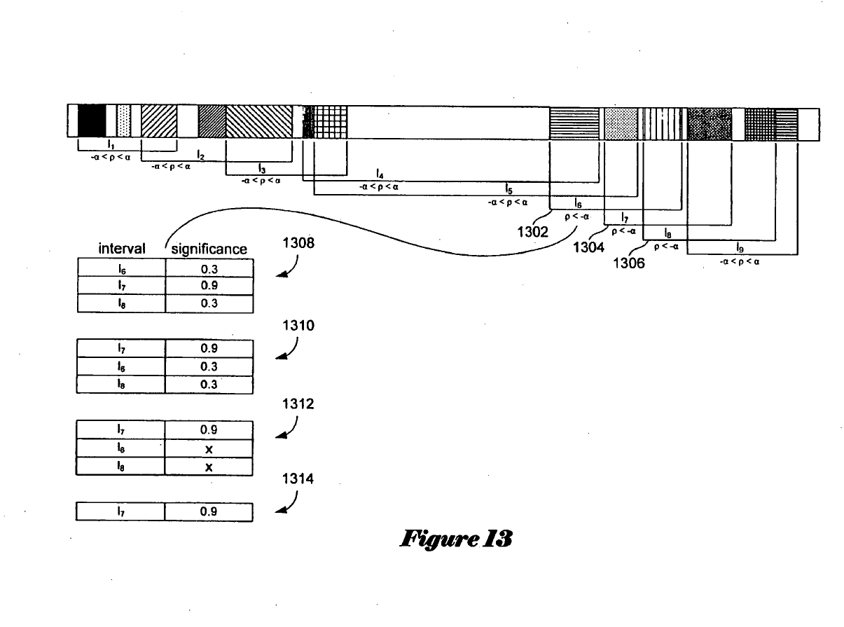

After the probabilities for the observed values for intervals are computed, those intervals with computed probabilities outside of a reasonable range of expected probabilities under the null hypothesis of no amplification or deletion are identified, and redundancies in the list of identified intervals are removed. In this way, intervals with statistical scores that differ from a threshold range bounded by a first threshold value and a second threshold value are identified as comprising copy number aberrations, e.g., deletions or amplifications, in the biopolymer sequence, e.g., chromosome. FIG. 13 illustrates one method for identifying and ranking intervals and removing redundancies from lists of intervals identified as corresponding to probable deletions or amplifications. In FIG. 13, the intervals for which probabilities are computed along the chromosome C₁ (402 in FIG. 4) for diseased tissue with an abnormal chromosome (502 in FIG. 5) are shown. Each interval is labeled by an interval number, Iₓ, where x ranges from 1 to 9. For most intervals, the calculated probability falls within a range of probabilities consonant with the null hypothesis. In other words, neither amplification nor deletion is indicated for most of the intervals. However, for intervals I₆ 1302, I₇, 1304, and I₈, 1306, the computed probabilities fall below the range of probabilities expected for the null hypothesis, indicating potential subsequence deletion in the diseased-tissue sample. (Note that if the computed probabilities were above the range of probabilities expected for the null hypothesis, potential subsequence amplification in the diseased-tissue sample would be indicated). These three intervals are placed into an initial list 1308 which is ordered by the significance of the computed probability into an ordered list 1310. Note that interval I₇ 1304 exactly includes those subsequences deleted in the diseased-tissue chromosome (502 in FIG. 5), and therefore reasonably has the highest significance with respect to falling outside the probability range of the null hypothesis. Next, all intervals overlapping an interval occurring higher in the ordered list are removed, as shown in list 1312, where overlapping intervals I₆ and I₈, with less significance, are removed, as indicated by the character X placed into the significance column for the entries corresponding to intervals I₆ and I₈. The end result is a list containing a single interval 1314 that indicates the interval most likely coinciding with the deletion. The final list for real chromosomes, containing thousands of subsequences and analyzed using hundreds of intervals, may generally contain more than a single entry. Additional details regarding computation of interval scores can be found in “Efficient Calculation of Interval Scores for DNA Copy Number Data Analysis,” Lipson et al., Proceedings of RECOMB 2005, LNCS 3500, p. 83, Springer-Verlag.

Various embodiments of the present invention may employ a centralization constant, e.g., as described in U.S. application Ser. No. 11/338,515; the disclosure of which centralization constant based methods is herein incorporated by reference. Briefly, in such methods one may determine a zero point, or centralization constant ζ, for an array-based comparative genomic hybridization (“aCGH”) data set by identifying a zero-point value, or centralization constant ζ, that, when used in an aberration-calling analysis of the aCGH data, results in the fewest number of array-probe-complementary genomic sequences identified as having abnormal copy numbers with respect to a control genome, or, in other words, results in the greatest number of array-probe-complementary genomic sequences identified as having normal copy numbers. In one embodiment, interval-based analysis of an aCGH data set may be carried out using a range of putative zero-point values, and the zero-point value for which the maximum number of genomic sequences are determined to have normal copy numbers may then be selected.

Various embodiments of the present invention may employ a copy number aberration calling methods that account for a noise component in the signal, as described in co-pending U.S. patent application Ser. No. 11/492,472, having attorney docket number 10060627-1, filed Jul. 24, 2006 and incorporated by reference herein in its entirety. In certain of these embodiments, a combined noise factor (i.e., total noise factor) that includes both a local noise component (i.e., a probe-to-probe) noise component, and a global noise component is employed. As such, it is assumed in these embodiments of the invention that the noise of measurement includes both a local noise component that is independent for each subsequence along the chromosome, and independent for distinct probes (such that the local noise component is not correlated between different probes along the interval) and a global noise component, which noise component is correlated between probes along the interval.

### Determining Ranges for Boundaries and Height of a Copy Number Variation Interval

Because of the difficulties in determining the precise biological consequences of chromosomal abnormalities identified by CGH analyses, it is of interest to determine the confidence level of a CGH-identified chromosomal copy number variation interval. In other words, providing an assessment of the confidence level for the boundaries and height of a copy number chromosomal abnormality identified in a CGH assay allows for a more accurate assessment of its biological impact (e.g., whether a chromosomal abnormality is clinically relevant). As described below, the present invention is drawn to computing and reporting (e.g., in tabular or graphical view) confidence intervals, or ranges, around the determined numerical properties of biomolecular intervals having an identified aberrant copy number. Numerical properties include the boundary limits (e.g., confidence intervals for an identified boundary of an identified copy number variation interval) and a height value representing the average probe hybridization ratio of the identified copy number variation interval. In certain embodiments, the subject systems and methods are an extension of the StepGram approach described in “Efficient Calculation of Interval Scores for DNA Copy Number Data Analysis,” Lipson et al., Proceedings of RECOMB 2005, LNCS 3500, p. 83, Springer-Verlag., incorporated by reference herein in its entirety.

In certain embodiments, the present invention is drawn to determining a range for one or both boundaries of an interval for a copy number variation in a biopolymer sequence identified in a CGH assay. In the description below, 1 represents the left boundary probe and r represents the right boundary probe for a series of contiguous probes that belong to identified aberrant interval A (also called the “best interval”). One calculates an aberration score Z for interval A that represents the deviation from the expected baseline of the average probe binding value for probes l through r [called Z(A_{l→r})]. In certain embodiments, Z(A_{l→r}) is based on the deviation of the average logRatio of binding of the probes l through r to the sample of interest compared to a control sample. In certain embodiments, the calculated aberration score is the same as the score calculated to identify the interval in the interval calling methods described in detail above (see formula for calculating C(k)).

Next, a value α is provided which represents how much score Z(A_{l→r}) can deviate from its peak, where 0≦α≦1. The value for a can be provided in a variety of ways. In certain embodiments, a is provided automatically by the system whereas in other embodiments α is provided by a user of the system (e.g., manually or by selection from a menu of options). Using a, a threshold deviation value D is calculated. In certain embodiments, D is calculated using the following formula:

D=Z(A_{l→r})−[(1−α/2)*Z(A_{l→r})]=(α/2)*Z(A_{l→r})

After calculating D, one can then determine a range interval, or confidence interval, for one or more, including each of, the boundaries. The range interval is a contiguous region encompassing the original boundary that represents how far the original boundary can be moved (while keeping the other boundary in its original position) without the score deviating more than D from the original aberration score Z(A_{l→r}).

For example, to determine the left range interval boundary for the left boundary I (l_{LEFT}), one holds r at its original position, moves the left boundary to the next adjacent probe outside of A_{l→r} (l−1), and determines Z(A_{(l-1)→r}). If the absolute value of Z(A_{l→r})−Z(A_{(l-1)→r}) is less than or equal to D, the left boundary is moved to the next adjacent probe (the l−2 position) and score Z(A_{(l-2)→r}) is determined. If the absolute value of Z(A_{l→r})−Z(A_{(l-2)→r}) is less than or equal to D, the left boundary is again moved to the next adjacent probe (the l−3 position), and so on. When, for the first time in this process, the absolute value of Z(A_{l→r})−Z(A_{(l-x)→r}) is greater than D, l_{LEFT} is set at the position of probe l−(x+1).

A similar process is followed to determine the right range interval boundary for the left boundary l (l_{RIGHT}), except that the left boundary is iteratively moved to an adjacent probe inside of A_{l→r} (in the +1 direction). When the absolute value of Z(A(_{l+y)→r})−Z(A_{l→r}) is more than D, for the first time, l_{RIGHT} is set at probe position l+(y−1).

At the completion of this process, a range interval for the left boundary of A_{l→r} has been determined. As indicated above, this range interval is a contiguous region spanning probes l_{LEFT}→l_{RIGHT} which includes original boundary probe l.

In certain embodiments, the range interval determination process described for the left boundary of A_{l→r} can be applied to the right boundary of A_{l→r}. In this case, the left boundary is maintained in its original position (or “best interval” position) and the right boundary is moved to find r_{LEFT} and r_{RIGHT}. It is noted here that it is not necessarily the case that every possible interval that starts within the left boundary range interval (l_{LEFT}→l_{RIGHT}) and ends in the right boundary range interval (r_{LEFT}→r_{RIGHT}) has a score that is within the deviation value D of Z(A_{l→r}).

In certain embodiments, once the left and right boundary range intervals have been determined, all possible intervals with boundaries that start within the left boundary range interval and end in the right boundary range interval sets are determined and scored. In certain of these embodiments, the end points are then adjusted so that every subinterval of the modified interval has a score that is within the deviation value D of Z (A_{l→r}).

In certain embodiments, the height range interval for the score of an identified aberrant interval (e.g., the height C(k), or h, as described above) is determined. The height range interval can be considered a measure of the noise along the identified aberrant interval (e.g., aberrant interval A_{l→r}). In certain of these embodiments, the range boundary is calculated as the standard deviation of the score for the identified aberration interval (e.g., the empirical standard deviation of the average logRatio of binding of the probe to the sample of interest compared to a control sample). In such embodiments, the height range boundary is set as the calculated score±the standard deviation.

In addition to the above-described boundary range determination methods, a computer-implemented method for viewing the boundary ranges is provided. In certain embodiments, the method provides a graphical user interface in which a copy number aberration interval (or multiple intervals) and height are visualized along with graphical representation(s) of the range for the aberrant interval boundary (or boundaries) and/or the height are displayed.

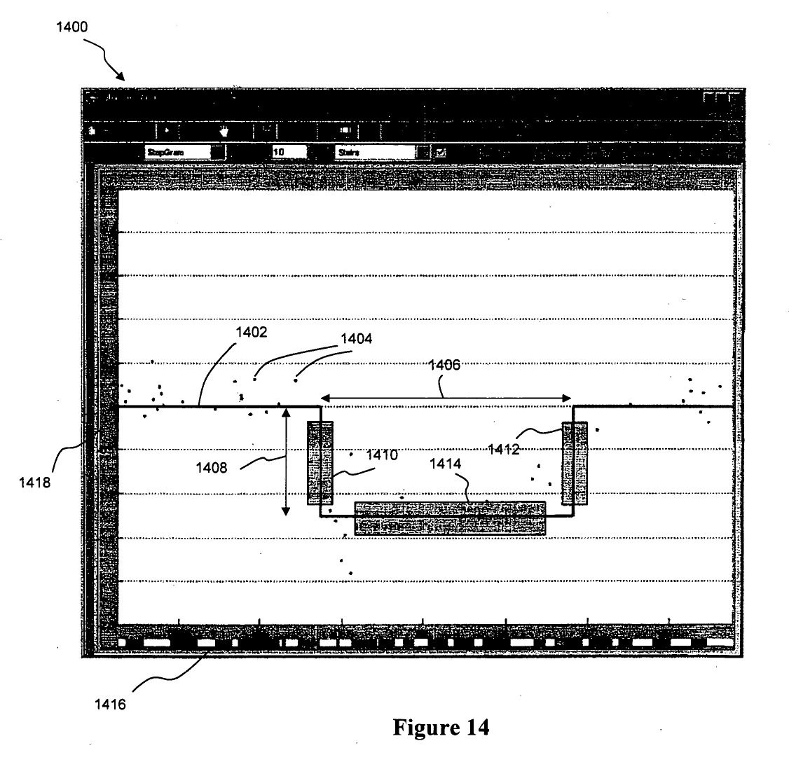

One embodiment of the visualization scheme of the invention is provided in FIG. 14 in which screen capture 1400 shows a copy number variation interval using stairs-function. In screen capture 1400, the Y axis 1418 of the graph represents a probe binding value (e.g., logRatio of binding for control sample versus sample of interest) while the X axis 1416 represents the location along the biopolymer of interest (e.g., chromosome). Line 1402 is held at a neutral position (i.e., at the zero point of the Y axis) at non-aberrant intervals. Identified aberrant interval 1406 is shown as a well in line 1402, with the beginning of the well indicating the left boundary l of the interval, the end of the well indicating the right boundary r of the interval, and the depth of the well indicating the height h of the aberrant interval (e.g., the score for the interval, as described above). In certain embodiments, the probe binding value for each probe is shown in the graphical display (e.g., dot elements 1404). In FIG. 14, the range boundaries for each of the left boundary, right boundary, and height value of the aberrant interval are shown as shaded, semi transparent boxes 1410, 1412 and 1414, respectively. The left and right boundaries of boxes 1410 and 1412 represent the left and right range interval boundaries as calculated above (i.e., l_{LEFT}, l_{RIGHT}, r_{LEFT} and r_{RIGHT}) while the upper and lower limits of box 1414 represents the range boundaries for the height, as calculated above.

In certain embodiments, the range boundaries are displayed to a user in table format as opposed to, or in conjunction with, the graphical representation shown in FIG. 14. In certain embodiments, the range intervals for the left and right boundaries are indicated by the probe/chromosomal location for each range boundary and the height range boundary is indicated by a range value (e.g, the height±a certain value, as calculated and described above).

The visualization schemes described above can be combined with any other visualization and user interface schemes for displaying/reporting aberrations in one or more samples measured by aCGH or any other technology. For example, the methods of the current invention can be combined with the visualization schemes of Kincaid et al. (R. Kincaid, A. Ben-Dor, Z. Yakhini, Exploratory visualization of array-based comparative genomic hybridization, Information Visualization 4, 3 (2005) 176).

Therefore, the above description is not meant to limit how the range intervals for the aberrant interval boundaries are communicated/displayed to a user, and as such, any convenient method may be employed to accomplish this task.

In certain embodiments, the user interface may allow a user to select a particular aberration calling method, and execute (e.g., by means of a clickable button) the selected aberration calling method. In certain embodiments, a user may also change input parameters, such as the threshold probability value used to call an aberration, and overlap parameters, using the user interface prior to executing the method.

A subset or all of the graphical representations may be selected (e.g., by checking a field associated with the graphical representations) to view aberrant regions therein. In certain embodiments, once executed, the method may produce a list of aberrant intervals in a selected region that may be viewed in the graphical user interface. Aberrant interval regions may be selected from the list, and the selected aberrant intervals may be indicated on the graphical representations containing that region, e.g., as described above. The instant programming may provide for zoom in and zoom out functions to allow a user to view a selected region of a chromosome in greater detail, or less detail, as desired.

Annotation information for an identified aberrant interval (e.g., a list of names for gene that are in the aberrant interval region) may be obtained by executing an annotation-retrieval method, e.g., by depressing a button that executes that method. In certain embodiments, the annotation information may open as a separate window to the graphical user interface discussed above.

In certain embodiments, the visualization scheme employed can be controlled by the user. For example, the degree of shade that denotes ranges can be selected and/or controlled from the user interface. In addition, when viewing lists of gene names in and/or adjacent to an aberrant interval, the names of genes in the boundary ranges can be greyed down. For example, the color intensity for genes in boundary ranges can be lower than for genes fully within the aberrant interval but higher than genes that fall outside the aberrant interval (i.e., genes adjacent to the aberrant interval).

The subject method includes executing computer-readable instructions that are at a remote location to the user, and transmitting data from the remote location to the graphical user interface at the user's location. In certain embodiments, the data sets may be received from a remote location, and the programming executed locally to the user.

The above-described computer-implemented method may be executed using programming that may be written in one or more of any number of computer programming languages. Such languages include, for example, Java (Sun Microsystems, Inc., Santa Clara, Calif.), Visual Basic (Microsoft Corp., Redmond, Wash.), and C++ (AT&T Corp., Bedminster, N.J.), as well as any many others.

Appropriate operating systems for use in conjunction with the programming include, but are not limited to, Solaris (Sun Microsystems, Inc., Santa Clara, Calif.), Windows (Microsoft Corp., Redmond, Wash.), Mac (Apple Computer, Inc., Cupertino, Calif.), or Linux (Red Hat, Inc., Raleigh, N.C.). Appropriate software applications include, but are not limited to, relational databases such as Oracle 9.0.1 (9i) (Oracle Corp., Redwood Shores, Calif.), DB2 Universal Database V8.1 (IBM Corp., Armonk, N.Y.), PostgreSQL (PostgreSQL, Inc., Wolfville, NS Canada), or SQL Server 2000 (Microsoft Corp., Redmond, Wash.).

As noted above, one embodiment involves two tiers of infrastructure: a server tier and a client tier. In one embodiment, the server tier may be an workgroup server (Sun Microsystems, Inc., Santa Clara, Calif.), the operating system may be Solaris (Sun Microsystems, Inc., Santa Clara, Calif.), and the database software may be Oracle 9.0.1 (9i) (Oracle Corp., Redwood Shores, Calif.). In the same embodiment, the client tier may operate using the Windows operating system (Microsoft Corp., Redmond, Wash.). In this embodiment, a Java language-based application, running on the client may contain both business and presentation logic. A Java Runtime Engine (JRE) may interpret and execute the compiled application within the client operating system (e.g. Windows). In addition to proprietary presentation and business logic, the client application may rely on third party application programming interfaces (APIs) for common functionality such as application connectivity and database connectivity. Installing APIs and a database on a server may provide a scalable solution for information sharing and propagating updates among numerous client applications. Each client may communicate with a server-based APIs through the local area network using common protocols (e.g. TCP/IP) supported by both the client and server operating systems (e.g. Windows and Solaris).

### Computer Readable Media

In certain embodiments, the above-described methods are coded onto a computer-readable medium in the form of programming, where the term “computer readable medium” as used herein refers to any storage or transmission medium that participates in providing instructions and/or data to a computer for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external to the computer. A file containing information may be “stored” on computer readable medium, where “storing” means recording information such that it is accessible and retrievable at a later date by a computer.

In certain embodiments, a computer-readable medium comprising instructions for producing the above-described graphical user interface is provided.

With respect to computer readable media, “permanent memory” refers to memory that is permanent. Permanent memory is not erased by termination of the electrical supply to a computer or processor. Computer hard-drive ROM (i.e. ROM not used as virtual memory), CD-ROM, floppy disk and DVD are all examples of permanent memory. Random Access Memory (RAM) is an example of non-permanent memory. A file in permanent memory may be editable and re-writable.

A computer-based system comprising the above-referenced computer readable medium is also provided. The minimum hardware of the computer-based systems of the present invention comprises a central processing unit (CPU), input means, output means, and data storage means. A skilled artisan can readily appreciate that any one of the currently available computer-based system are suitable for use in the present invention. The data storage means may comprise any manufacture comprising a recording of the present information as described above, or a memory access means that can access such a manufacture.

To “record” data, programming or other information on a computer readable medium refers to a process for storing information, using any such methods as known in the art. Any convenient data storage structure may be chosen, based on the means used to access the stored information. A variety of data processor programs and formats can be used for storage, e.g. word processing text file, database format, etc.

A “processor” references any hardware and/or software combination that will perform the functions required of it. For example, any processor herein may be a programmable digital microprocessor such as available in the form of a electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

One or more platforms present in the subject systems may be any type of known computer platform or a type to be developed in the future, although they typically will be of a class of computer commonly referred to as servers. However, they may also be a main-frame computer, a work station, or other computer type. They may be connected via any known or future type of cabling or other communication system including wireless systems, either networked or otherwise. They may be co-located or they may be physically separated. Various operating systems may be employed on any of the computer platforms, possibly depending on the type and/or make of computer platform chosen. Appropriate operating systems include Windows NT®, Sun Solaris, Linux, OS/400, Compaq Tru64 Unix, SGI IRIX, Siemens Reliant Unix, and others.

In certain embodiments, the subject devices include multiple computer platforms which may provide for certain benefits, e.g., lower costs of deployment, database switching, or changes to enterprise applications, and/or more effective firewalls. Other configurations, however, are possible. For example, as is well known to those of ordinary skill in the relevant art, so-called two-tier or N-tier architectures are possible rather than the three-tier server-side component architecture represented by, for example, E. Roman, Mastering Enterprise JavaBeans™ and the Java™2 Platform (John Wiley & Sons, Inc., NY, 1999) and J. Schneider and R. Arora, Using Enterprise Java. (Que Corporation, Indianapolis, 1997).

It will be understood that many hardware and associated software or firmware components that may be implemented in a server-side architecture for Internet commerce are known and need not be reviewed in detail here. Components to implement one or more firewalls to protect data and applications, uninterruptable power supplies, LAN switches, web-server routing software, and many other components are not shown. Similarly, a variety of computer components customarily included in server-class computing platforms, as well as other types of computers, will be understood to be included but are not shown. These components include, for example, processors, memory units, input/output devices, buses, and other components noted above with respect to a user computer. Those of ordinary skill in the art will readily appreciate how these and other conventional components may be implemented.

The functional elements of system may also be implemented in accordance with a variety of software facilitators and platforms (although it is not precluded that some or all of the functions of system may also be implemented in hardware or firmware). Among the various commercial products available for implementing e-commerce web portals are BEA WebLogic from BEA Systems, which is a so-called “middleware” application. This and other middleware applications are sometimes referred to as “application servers,” but are not to be confused with application server hardware elements. The function of these middleware applications generally is to assist other software components (such as software for performing various functional elements) to share resources and coordinate activities.

Other development products, such as the Java™2 platform from Sun Microsystems, Inc. may be employed in the system to provide suites of applications programming interfaces (API's) that, among other things, enhance the implementation of scalable and secure components. Various other software development approaches or architectures may be used to implement the functional elements of system and their interconnection, as will be appreciated by those of ordinary skill in the art.

Additional system components, methods, arrays and kits may be include as are described in U.S. patent application Ser. No. 11/001700, filed Nov. 30, 2004, U.S. patent application Ser. No. 11/001672, filed Nov. 30, 2004 and U.S. patent application Ser. No. 11/000681, filed Nov. 30, 2004, the entireties of which are incorporated by reference herein.

### Kits

Kits for use in connection with the subject invention may also be provided. Such kits may include at least a computer readable medium including programming as discussed above and instructions. The instructions may include installation or setup directions. The instructions may include directions for use of the invention with options or combinations of options as described above. In certain embodiments, the instructions include both types of information.

Providing the software and instructions as a kit may serve a number of purposes. The combination may be packaged and purchased as a means of upgrading array analysis software. Alternately, the combination may be provided in connection with new software. In certain embodiments, the instructions will serve as a reference manual (or a part thereof) and the computer readable medium as a backup copy to the preloaded utility.

The instructions may be recorded on a suitable recording medium. For example, the instructions may be printed on a substrate, such as paper or plastic, etc. As such, the instructions may be present in the kits as a package insert, in the labeling of the container of the kit or components thereof (i.e., associated with the packaging or subpackaging), etc. In other embodiments, the instructions are present as an electronic storage data file present on a suitable computer readable storage medium, e.g., CD-ROM, diskette, etc, including the same medium on which the program is presented.

In yet other embodiments, the instructions are not themselves present in the kit, but means for obtaining the instructions from a remote source, e.g. via the Internet, are provided. An example of this embodiment is a kit that includes a web address where the instructions can be viewed and/or from which the instructions can be downloaded. Conversely, means may be provided for obtaining the subject programming from a remote source, such as by providing a web address. Still further, the kit may be one in which both the instructions and software are obtained or downloaded from a remote source, as in the Internet or world wide web. Some form of access security or identification protocol may be used to limit access to those entitled to use the subject invention. As with the instructions, the means for obtaining the instructions and/or programming is generally recorded on a suitable recording medium.

### Utility

The present invention provides systems and methods for determining and indicating to a user the range/confidence intervals for the boundaries and height of an identified aberrant copy number interval in CGH analyses. Researches can us this information to more accurately assess the biological meaning of a CGH (e.g., array-based CGH) identified chromosomal abnormality. As such, the present invention finds use in both clinical and basic research applications of CGH analyses.

Chromosomal copy number changes occur in a wide variety of disorders, including developmental disorders and cancer, as well as in individuals that display no apparent adverse phenotype. As such, in certain embodiments, the methods of the invention find use in analyzing comparative genome hybridization data in the context of asymptomatic individuals (e.g., in a genetic counseling setting) as well as in the context of disease diagnosis (e.g., cancer).

Arrays employed in CGH assays contain polynucleotides immobilized on a solid support. Array platforms for performing the array-based methods are generally well known in the art (e.g., see Pinkel et al., Nat. Genet. (1998) 20:207-211; Hodgson et al., Nat. Genet. (2001) 29:459-464; Wilhelm et al., Cancer Res. (2002) 62: 957-960) and, as such, need not be described herein in any great detail. In general, CGH arrays contain a plurality (i.e., at least about 100, at least about 500, at least about 1000, at least about 2000, at least about 5000, at least about 10,000, at least about 20,000, usually up to about 100,000 or more) of addressable features that are linked to a planar solid support. Features on a subject array usually contain a polynucleotide that hybridizes with, i.e., binds to, genomic sequences from a cell. Accordingly, such “comparative genome hybridization arrays”, for short “CGH arrays” typically have a plurality of different BACs, cDNAs, oligonucleotides, or inserts from phage or plasmids, etc., that are addressably arrayed. As such, CGH arrays usually contain surface bound polynucleotides that are about 10-200 bases in length, about 201-5000 bases in length, about 5001-50,000 bases in length, or about 50,001-200,000 bases in length, depending on the platform used.

In particular embodiments, CGH arrays containing surface-bound oligonucleotides, i.e., oligonucleotides of 10 to 100 nucleotides and up to 200 nucleotides in length, find particular use in the subject methods.

In general, the subject assays involve labeling a test and a reference genomic sample to make two labeled populations of nucleic acids which may be distinguishably labeled, contacting the labeled populations of nucleic acids with an array of surface bound polynucleotides under specific hybridization conditions, and analyzing any data obtained from hybridization of the nucleic acids to the surface bound polynucleotides. Such methods are generally well known in the art (see, e.g., Pinkel et al., Nat. Genet. (1998) 20:207-211; Hodgson et al., Nat. Genet. (2001) 29:459-464; Wilhelm et al., Cancer Res. (2002) 62: 957-960)) and, as such, need not be described herein in any great detail.

Two different genomic samples may be differentially labeled, where the different genomic samples may include an “experimental” sample, i.e., a sample of interest, and a “control” sample to which the experimental sample may be compared. In certain embodiments, the different samples are pairs of cell types or fractions thereof, one cell type being a cell type of interest, e.g., an abnormal cell, and the other a control, e.g., a normal cell. If two fractions of cells are compared, the fractions are usually the same fraction from each of the two cells. In certain embodiments, however, two fractions of the same cell type may be compared. Exemplary cell type pairs include, for example, cells isolated from a tissue biopsy (e.g., from a tissue having a disease such as colon, breast, prostate, lung, skin cancer, or infected with a pathogen etc.) and normal cells from the same tissue, usually from the same patient; cells grown in tissue culture that are immortal (e.g., cells with a proliferative mutation or an immortalizing transgene), infected with a pathogen, or treated (e.g., with environmental or chemical agents such as peptides, hormones, altered temperature, growth condition, physical stress, cellular transformation, etc.), and a normal cell (e.g., a cell that is otherwise identical to the experimental cell except that it is not immortal, infected, or treated, etc.); a cell isolated from a mammal with a cancer, a disease, a geriatric mammal, or a mammal exposed to a condition, and a cell from a mammal of the same species, preferably from the same family, that is healthy or young; and differentiated cells and non-differentiated cells from the same mammal (e.g., one cell being the progenitor of the other in a mammal, for example). In one embodiment, cells of different types, e.g., neuronal and non-neuronal cells, or cells of different status (e.g., before and after a stimulus on the cells, or in different phases of the cell cycle) may be employed. In another embodiment of the invention, the experimental material is cells susceptible to infection by a pathogen such as a virus, e.g., human immunodeficiency virus (HIV), etc., and the control material is cells resistant to infection by the pathogen. In another embodiment of the invention, the sample pair is represented by undifferentiated cells, e.g., stem cells, and differentiated cells.

The methods of the subject invention can be used to determine the association between the presence of amplifications and/or deletions in an individual's genome and the individual's susceptibility to a certain condition such as obesity, developmental disorders or the development of cancerous or pre-cancerous lesions. As such, the methods of the invention find use as a useful tool in clinical genomic counseling.

Results obtained from several such array-based CGH assays may be analyzed using the methods described above to identify common aberrations.

Although the present invention has been described in terms of a particular embodiment, it is not intended that the invention be limited to this embodiment. Modifications within the spirit of the invention will be apparent to those skilled in the art. For example, an almost limitless number of different implementations of computer programs and computer-program routines can be created to compute the above-described analysis methods for analyzing chromosomal aberrations in diseased-tissue samples when a number of control samples are available. Although recursive methods may be employed, more efficient, non-recursive algorithms can be employed to more efficiently compute the desired statistics. The above-described methods can be easily modified to encompass experimental data from many different organisms having different numbers of chromosomes, different numbers of subsequences per chromosome, and other genetic differences. In each component of the above-described method, many possible mathematically similar, but alternative approaches may be employed. For example, different methods for computing means and variances can be used, as well as different statistical parameters used to characterize particular distributions. Many different types of user-interface implementations, in addition to the user-interface implementation discussed above with reference to FIGS. 14A-16F can be employed to allow for convenient selection of parameters that control CGH analysis and various different CGH-data-analysis-results display formats.

The foregoing description, for purposes of explanation, used specific nomenclature to provide a thorough understanding of the invention. However, it will be apparent to one skilled in the art that the specific details are not required in order to practice the invention. The -foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for determining a range boundary for a CGH-identified aberrant copy number interval in a biopolymer sequence, said method comprising:
(a) obtaining a CGH-identified aberrant copy number interval, wherein said CGH-identified aberrant copy number interval comprises a first boundary, a second boundary and a score;
(b) calculating a threshold deviation value for said score; and
(c) determining a first range boundary for said CGH-identified aberrant copy number interval, wherein said first range boundary represents the range that said first boundary can be moved in either direction while holding said second boundary in its original position before the change in said score for said CGH-identified aberrant copy number interval exceeds said threshold deviation value.

2. The method of claim 1, wherein said method further comprises determining a second range boundary for said CGH-identified aberrant copy number interval, wherein said second range boundary represents the range that said second boundary can be moved in either direction while holding said first boundary in its original position before the change in said score for said CGH-identified aberrant copy number interval exceeds said threshold deviation value.

3. The method of claim 1, wherein said biopolymer sequence is a DNA sequence.

4. The method of claim 1, wherein said CGH-identified aberrant copy number interval is determined by an array-based, comparative hybridization method.

5. The method of claim 1, wherein said obtaining step (a) comprises:
1) obtaining a vector of signals from a CGH analysis comprising normalized hybridization levels for fragments of said biopolymer sequence;
2) generating a set of intervals within the vector of signals;
3) calculating a score for each interval; and
4) identifying aberrant copy number interval from among said intervals, wherein identified deleted intervals have scores that are below a first threshold and identified amplified intervals have scores that are above a second threshold.

6. The method of claim 2, wherein said method further comprises calculating a range for the height of said CGH-identified aberrant copy number interval.

7. The method of claim 6, wherein said method further comprises displaying a graphical representation to a user showing said first range boundary, said second range boundary and said range for said height of said CGH-identified aberrant copy number interval.

8. The method of claim 7, wherein said graphical representation comprises a stairs function graphic to represent said CGH-identified aberrant copy number interval in which said first range boundary, said second range boundary and said range for said height of said CGH-identified aberrant copy number interval are displayed as shaded boxes.

9. Computer instructions that implement the method of claim 1 stored in a computer readable medium.

10. A comparative hybridization data analysis system that includes hardware-implemented, firmware-implemented, software-implemented, or a combination of two or more of hardware-implemented, firmware-implemented, and software-implemented logic that implements the method of claim 1.

11. A user interface provided by a comparative-hybridization data-analysis system comprising:
a data-analysis-representation display area that displays an interval of a copy number variation in a biopolymer sequence with graphically encoded indications of a range for one or more of:
a first boundary of said interval;
a second boundary of said interval; and
a height of said interval; and
a user-interface that allows a user to set various parameters to control comparative-hybridization data analysis; wherein said user interface features include at least one of:
a feature that allows a user to select, input or calculate threshold values for identifying a CGH aberrant copy umber interval; and
a feature that allows a user to select, input or calculate a threshold deviation value.

12. The user interface of claim 11 further including displaying comparative-hybridization results for a particular sample of interest in a first color when the comparative-hybridization results fall within a corresponding range of values for control results, in a second color when the comparative-hybridization results fall above a corresponding range of values for control results, and in a third color when the comparative-hybridization results fall below a corresponding range of values for control results.

13. Computer instructions encoded in a computer readable medium that implement the user interface of claim 11.

14. A comparative hybridization data analysis system that includes hardware-implemented, firmware-implemented, software-implemented, or a combination of two or more of hardware-implemented, firmware-implemented, and software-implemented logic that implements the user interface of claim 11.


SEQUENCE LISTING (4 sequences)

SEQ ID NO: 1 - DNA, 31 bp, Artificial Sequence
  synthetic oligonucleotide
actatgacgctttccatcgggctagctctca

SEQ ID NO: 2 - DNA, 31 bp, Artificial Sequence
  synthetic oligonucleotide
tgagagctagcccgatggaaagcgtcatagt

SEQ ID NO: 3 - RNA, 21 nt, Artificial Sequence
  synthetic oligonucleotide
acuaugacgcuuuccaucggg

SEQ ID NO: 4 - protein, 6 aa, Artificial Sequence
  synthetic peptide
YDAFHR